(19) United States
(12) Patent Application Publication
(10) Pub. No.: US 2026/0352010 A1
(43) Pub. Date: Nov. 5, 2026

(54) MULTI-PORT OUTPUT CHARGING APPARATUS AND FULL-TIME DYNAMIC POWER ALLOCATION METHOD

(71) Applicant: DELTA ELECTRONICS, INC., Taoyuan City (TW)

(72) Inventors: Yi-Sin WANG, Taoyuan City (TW); Ruei-Lin HUNG, Taoyuan City (TW); Yi-Mou LI, Taoyuan City (TW); Po-Lin HUANG, Taoyuan City (TW)

(21) Appl. No.: 19/306,602

(22) Filed: Aug. 21, 2025

(30) Foreign Application Priority Data
Apr. 30, 2025 (CN) 202510565094.5

(51) Int. Cl. H02J 7/94; H02J 7/42; H02J 7/50; H02J 7/80; H02J 7/96

(52) U.S. Cl. CPC H02J 7/94; H02J 7/42; H02J 7/50; H02J 7/80; H02J 7/96

(57) ABSTRACT

A multi-port output charging apparatus calculates a first actual average charging power value of a first electronic apparatus and a second actual average charging power value of a second electronic apparatus. The first actual average charging power value is less than a first predetermined percentage of a first allocated charging power value allocated to the first electronic apparatus. A second allocated charging power value allocated to the second electronic apparatus is less than a second charging specification power value of the second electronic apparatus. The multi-port output charging apparatus subtracts the first actual average charging power value from the first allocated charging power value to obtain an idle power value, multiplies the idle power value by a second predetermined percentage to obtain an allocating power value, and allocates the allocating power value to the second electronic apparatus.

### BACKGROUND OF THE DISCLOSURE

### Technical Field

The present disclosure relates to a charging apparatus and a power allocation method, and especially relates to a multi-port output charging apparatus and a full-time dynamic power allocation method.

### Description of Related Art

The multi-port output charging apparatus may simultaneously charge multiple electronic apparatuses, so that the multi-port output charging apparatus is very convenient. When an electronic apparatus is plugged into the multi-port output charging apparatus, the multi-port output charging apparatus communicates with the electronic apparatus. For example, the multi-port output charging apparatus provides power specifications for the electronic apparatus to select. Thereafter, the multi-port output charging apparatus supplies the electronic apparatus with a fixed power specification and retains the power for the electronic apparatus to draw until the electronic apparatus is removed from the multi-port output charging apparatus, and then the multi-port output charging apparatus reallocates the power.

For example, a multi-port output charging apparatus with a power of 100 watts charges an electronic apparatus with a power requirement of 65 watts. When the multi-port output charging apparatus communicates with the electronic apparatus, the multi-port output charging apparatus decides to retain 65 watts for charging the electronic apparatus. When the battery level of the electronic apparatus is low, the electronic apparatus may draw 60 watts. As the battery gradually charges, the electronic apparatus may only draw 20 watts, but the multi-port output charging apparatus still retains 65 watts of power for the electronic apparatus. At this point, the remaining power available for allocation from the other charging ports is only 35 watts, so that the charging time for other electronic apparatuses connected to the other charging ports may be very long.

### SUMMARY OF THE INVENTION

In order to solve the above-mentioned problems, an object of the present disclosure is to provide a multi-port output charging apparatus.

In order to solve the above-mentioned problems, another object of the present disclosure is to provide a full-time dynamic power allocation method.

In order to achieve the object of the present disclosure mentioned above, the multi-port output charging apparatus of the present disclosure is applied to a first electronic apparatus and a second electronic apparatus. The multi-port output charging apparatus includes: a microcontroller, a charging circuit, and a current detection circuit. The charging circuit is electrically connected to the microcontroller. The current detection circuit is electrically connected to the microcontroller. Moreover, the current detection circuit is configured to detect a first charging current provided by the charging circuit to charge the first electronic apparatus, and inform the microcontroller of a first charging current value of the first charging current. The microcontroller is configured to calculate a first actual average charging power value of the first electronic apparatus based on a plurality of the first charging current values within a predetermined time. The first actual average charging power value is less than a first predetermined percentage of a first allocated charging power value allocated by the charging circuit to the first electronic apparatus. Moreover, the current detection circuit is configured to detect a second charging current provided by the charging circuit to charge the second electronic apparatus, and inform the microcontroller of a second charging current value of the second charging current. The microcontroller is configured to calculate a second actual average charging power value of the second electronic apparatus based on a plurality of the second charging current values within the predetermined time. A second allocated charging power value allocated by the charging circuit to the second electronic apparatus is less than a second charging specification power value of the second electronic apparatus. Moreover, the microcontroller is configured to subtract the first actual average charging power value from the first allocated charging power value to obtain an idle power value, and multiply the idle power value by a second predetermined percentage to obtain an allocating power value, and allocate the allocating power value to a power sharing pool, and allocate at least a portion of the allocating power value to the second electronic apparatus via the charging circuit.

Moreover, in an embodiment of the multi-port output charging apparatus of the present disclosure mentioned above, the multi-port output charging apparatus is further applied to a third electronic apparatus. Moreover, the current detection circuit is configured to detect a third charging current provided by the charging circuit to charge the third electronic apparatus, and inform the microcontroller of a third charging current value of the third charging current. The microcontroller is configured to calculate a third actual average charging power value of the third electronic apparatus based on a plurality of the third charging current values within the predetermined time. A third allocated charging power value allocated by the charging circuit to the third electronic apparatus is less than a third charging specification power value of the third electronic apparatus. Moreover, the microcontroller is configured to allocate the allocating power value to the second electronic apparatus and the third electronic apparatus via the charging circuit.

Moreover, in an embodiment of the multi-port output charging apparatus of the present disclosure mentioned above, the microcontroller is configured to allocate the allocating power value evenly to the second electronic apparatus and the third electronic apparatus via the charging circuit, or, based on charging voltage specifications, charging current specifications, charging power specifications, or brands of the second electronic apparatus and the third electronic apparatus, the microcontroller is configured to allocate the allocating power value to the second electronic apparatus and the third electronic apparatus via the charging circuit.

Moreover, in an embodiment of the multi-port output charging apparatus of the present disclosure mentioned above, the multi-port output charging apparatus is further applied to a fourth electronic apparatus. The multi-port output charging apparatus further includes: a plurality of common charging ports and a priority charging port. The common charging ports are electrically connected to the microcontroller and the charging circuit. The first electronic apparatus, the second electronic apparatus, and the third electronic apparatus are plugged into the common charging ports. The priority charging port is electrically connected to the microcontroller and the charging circuit. The fourth electronic apparatus is plugged into the priority charging port. Moreover, the charging circuit is configured to allocate a fourth allocated charging power value equal to a fourth charging specification power value of the fourth electronic apparatus to the fourth electronic apparatus.

Moreover, in an embodiment of the multi-port output charging apparatus of the present disclosure mentioned above, in a first power allocation of the multi-port output charging apparatus, the charging circuit is configured to allocate the fourth allocated charging power value equal to the fourth charging specification power value of the fourth electronic apparatus to the fourth electronic apparatus. In the first power allocation of the multi-port output charging apparatus, the charging circuit is configured to set the first allocated charging power value of the first electronic apparatus, the second allocated charging power value of the second electronic apparatus, and the third allocated charging power value of the third electronic apparatus, based on a ratio among a first charging specification power value of the first electronic apparatus, the second charging specification power value of the second electronic apparatus, and the third charging specification power value of the third electronic apparatus, using a remaining power value obtained by subtracting the fourth allocated charging power value from a charging capability maximum wattage value of the charging circuit, or, the charging circuit is configured to set the first allocated charging power value of the first electronic apparatus, the second allocated charging power value of the second electronic apparatus, and the third allocated charging power value of the third electronic apparatus, based on the charging voltage specifications, the charging current specifications, the charging power specifications, or the brands of the first electronic apparatus, the second electronic apparatus, and the third electronic apparatus, using the remaining power value obtained by subtracting the fourth allocated charging power value from the charging capability maximum wattage value of the charging circuit.

In order to achieve the object of the present disclosure mentioned above, the full-time dynamic power allocation method of the present disclosure is applied to a multi-port output charging apparatus, a first electronic apparatus, and a second electronic apparatus. The multi-port output charging apparatus includes a microcontroller, a charging circuit, and a current detection circuit. The full-time dynamic power allocation method includes the following steps. The current detection circuit detects a first charging current provided by the charging circuit to charge the first electronic apparatus. The current detection circuit informs the microcontroller of a first charging current value of the first charging current. The microcontroller calculates a first actual average charging power value of the first electronic apparatus based on a plurality of the first charging current values within a predetermined time, wherein the first actual average charging power value is less than a first predetermined percentage of a first allocated charging power value allocated by the charging circuit to the first electronic apparatus. The current detection circuit detects a second charging current provided by the charging circuit to charge the second electronic apparatus. The current detection circuit informs the microcontroller of a second charging current value of the second charging current. The microcontroller calculates a second actual average charging power value of the second electronic apparatus based on a plurality of the second charging current values within the predetermined time, wherein a second allocated charging power value allocated by the charging circuit to the second electronic apparatus is less than a second charging specification power value of the second electronic apparatus. The microcontroller subtracts the first actual average charging power value from the first allocated charging power value to obtain an idle power value. The microcontroller multiplies the idle power value by a second predetermined percentage to obtain an allocating power value. The microcontroller allocates the allocating power value to a power sharing pool. The microcontroller allocates at least a portion of the allocating power value to the second electronic apparatus via the charging circuit.

Moreover, in an embodiment of the full-time dynamic power allocation method of the present disclosure mentioned above, the full-time dynamic power allocation method is further applied to a third electronic apparatus. The full-time dynamic power allocation method further includes the following steps. The current detection circuit detects a third charging current provided by the charging circuit to charge the third electronic apparatus. The current detection circuit informs the microcontroller of a third charging current value of the third charging current. The microcontroller calculates a third actual average charging power value of the third electronic apparatus based on a plurality of the third charging current values within the predetermined time, wherein a third allocated charging power value allocated by the charging circuit to the third electronic apparatus is less than a third charging specification power value of the third electronic apparatus. The microcontroller allocates the allocating power value to the second electronic apparatus and the third electronic apparatus via the charging circuit.

Moreover, in an embodiment of the full-time dynamic power allocation method of the present disclosure mentioned above, the microcontroller allocating the allocating power value to the second electronic apparatus and the third electronic apparatus via the charging circuit is that: the microcontroller allocates the allocating power value evenly to the second electronic apparatus and the third electronic apparatus via the charging circuit, or, based on charging voltage specifications, charging current specifications, charging power specifications, or brands of the second electronic apparatus and the third electronic apparatus, the microcontroller allocates the allocating power value to the second electronic apparatus and the third electronic apparatus via the charging circuit.

Moreover, in an embodiment of the full-time dynamic power allocation method of the present disclosure mentioned above, the full-time dynamic power allocation method is further applied to a fourth electronic apparatus. The multi-port output charging apparatus further includes a plurality of common charging ports and a priority charging port. The first electronic apparatus, the second electronic apparatus, and the third electronic apparatus are plugged into the common charging ports. The fourth electronic apparatus is plugged into the priority charging port. The full-time dynamic power allocation method further includes the following steps. The charging circuit allocates a fourth allocated charging power value equal to a fourth charging specification power value of the fourth electronic apparatus to the fourth electronic apparatus.

Moreover, in an embodiment of the full-time dynamic power allocation method of the present disclosure mentioned above, in a first power allocation of the multi-port output charging apparatus, the charging circuit allocates the fourth allocated charging power value equal to the fourth charging specification power value of the fourth electronic apparatus to the fourth electronic apparatus. In the first power allocation of the multi-port output charging apparatus, the charging circuit sets the first allocated charging power value of the first electronic apparatus, the second allocated charging power value of the second electronic apparatus, and the third allocated charging power value of the third electronic apparatus, based on a ratio among a first charging specification power value of the first electronic apparatus, the second charging specification power value of the second electronic apparatus, and the third charging specification power value of the third electronic apparatus, using a remaining power value obtained by subtracting the fourth allocated charging power value from a charging capability maximum wattage value of the charging circuit, or, the charging circuit sets the first allocated charging power value of the first electronic apparatus, the second allocated charging power value of the second electronic apparatus, and the third allocated charging power value of the third electronic apparatus, based on the charging voltage specifications, the charging current specifications, the charging power specifications, or the brands of the first electronic apparatus, the second electronic apparatus, and the third electronic apparatus, using the remaining power value obtained by subtracting the fourth allocated charging power value from the charging capability maximum wattage value of the charging circuit.

The advantage of the present disclosure is to reduce the charging time for multiple electronic apparatuses connected to the multi-port output charging apparatus.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a block diagram of an embodiment of the multi-port output charging apparatus of the present disclosure.

FIG. 2 shows a flowchart of the operating method of the multi-port output charging apparatus of the present disclosure.

FIG. 3 shows a flowchart of the average allocation method of the allocating power value of the present disclosure.

FIG. 4 shows a flowchart of the allocation method of the allocating power value based on the charging voltage specifications of the present disclosure.

FIG. 5 shows a flowchart of the allocation method of the allocating power value based on the charging current specifications of the present disclosure.

FIG. 6 shows a flowchart of the allocation method of the allocating power value based on the charging power specifications of the present disclosure.

FIG. 7 shows a flowchart of the allocation method of the allocating power value based on the brand information of the present disclosure.

FIG. 8 shows a flowchart of a part of the full-time dynamic power allocation method of the present disclosure.

FIG. 9 shows a flowchart of another part of the full-time dynamic power allocation method of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

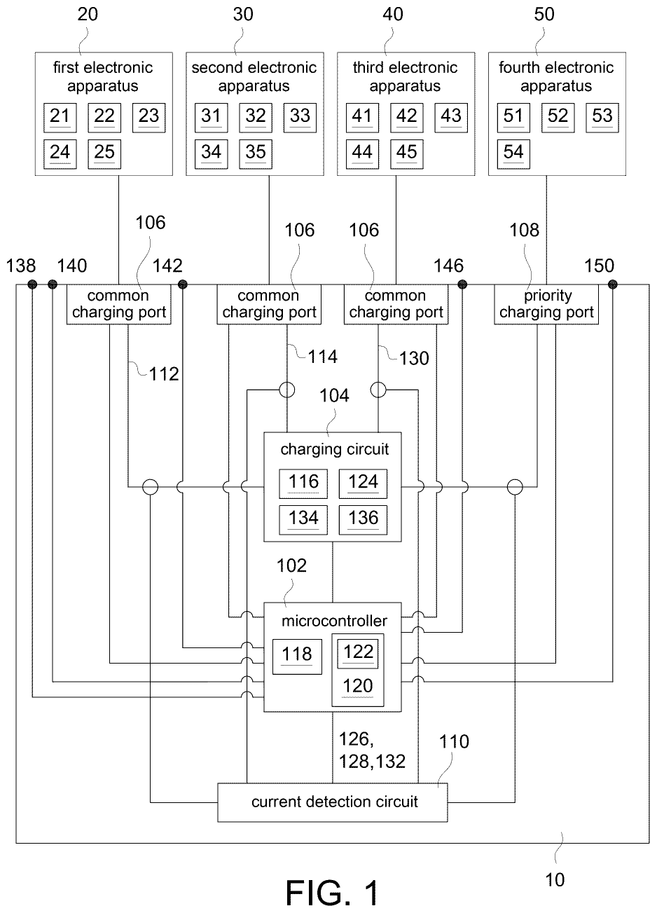

FIG. 1 shows a block diagram of an embodiment of the multi-port output charging apparatus 10 of the present disclosure. The multi-port output charging apparatus 10 of the present disclosure is applied to a first electronic apparatus 20, a second electronic apparatus 30, a third electronic apparatus 40, and a fourth electronic apparatus 50. The multi-port output charging apparatus 10 includes a microcontroller 102, a charging circuit 104, a current detection circuit 110, a plurality of common charging ports 106, and a priority charging port 108. The microcontroller 102 is electrically connected to the charging circuit 104, the current detection circuit 110, the common charging ports 106, and the priority charging port 108. The charging circuit 104 is also electrically connected to the common charging ports 106 and the priority charging port 108.

The first electronic apparatus 20, the second electronic apparatus 30, and the third electronic apparatus 40 are plugged into the common charging ports 106. Namely, the first electronic apparatus 20 is plugged into the first common charging port 106 from left to right in FIG. 1. The second electronic apparatus 30 is plugged into the second common charging port 106 from left to right in FIG. 1. The third electronic apparatus 40 is plugged into the third common charging port 106 from left to right in FIG. 1. The fourth electronic apparatus 50 is plugged into the priority charging port 108.

When the first electronic apparatus 20, the second electronic apparatus 30, and the third electronic apparatus 40 are plugged into the common charging ports 106, and the fourth electronic apparatus 50 is plugged into the priority charging port 108, the first electronic apparatus 20, the second electronic apparatus 30, the third electronic apparatus 40, and the fourth electronic apparatus 50 communicate with the microcontroller 102, so that the microcontroller 102 is aware of the charging requirements of the first electronic apparatus 20, the second electronic apparatus 30, the third electronic apparatus 40, and the fourth electronic apparatus 50, such that the microcontroller 102 controls the charging circuit 104 to charge the first electronic apparatus 20, the second electronic apparatus 30, the third electronic apparatus 40, and the fourth electronic apparatus 50.

More specifically, the first electronic apparatus 20 includes a first charging specification voltage value 21, a first charging specification current value 22, a first charging specification power value 23, and a first brand information 24, wherein the first charging specification power value 23 represents the maximum power in watts required for charging the first electronic apparatus 20. When the first electronic apparatus 20 is plugged into the first common charging port 106 from left to right in FIG. 1, the first electronic apparatus 20 transmits the first charging specification voltage value 21, the first charging specification current value 22, the first charging specification power value 23, and the first brand information 24 to the microcontroller 102.

Similarly, the second electronic apparatus 30 includes a second charging specification voltage value 31, a second charging specification current value 32, a second charging specification power value 33, and a second brand information 34, wherein the second charging specification power value 33 represents the maximum power in watts required for charging the second electronic apparatus 30. When the second electronic apparatus 30 is plugged into the second common charging port 106 from left to right in FIG. 1, the second electronic apparatus 30 transmits the second charging specification voltage value 31, the second charging specification current value 32, the second charging specification power value 33, and the second brand information 34 to the microcontroller 102.

The third electronic apparatus 40 includes a third charging specification voltage value 41, a third charging specification current value 42, a third charging specification power value 43, and a third brand information 44, wherein the third charging specification power value 43 represents the maximum power in watts required for charging the third electronic apparatus 40. When the third electronic apparatus 40 is plugged into the third common charging port 106 from left to right in FIG. 1, the third electronic apparatus 40 transmits the third charging specification voltage value 41, the third charging specification current value 42, the third charging specification power value 43, and the third brand information 44 to the microcontroller 102.

The fourth electronic apparatus 50 includes a fourth charging specification voltage value 51, a fourth charging specification current value 52, a fourth charging specification power value 53, and a fourth brand information 54, wherein the fourth charging specification power value 53 represents the maximum power in watts required for charging the fourth electronic apparatus 50. When the fourth electronic apparatus 50 is plugged into the priority charging port 108, the fourth electronic apparatus 50 transmits the fourth charging specification voltage value 51, the fourth charging specification current value 52, the fourth charging specification power value 53, and the fourth brand information 54 to the microcontroller 102.

The first charging specification voltage value 21, the second charging specification voltage value 31, the third charging specification voltage value 41, and the fourth charging specification voltage value 51 may be, for example but not limited to, 5 volts, 9 volts, 12 volts, 15 volts, 20 volts, or 28 volts.

After the microcontroller 102 receives the above values and information to be aware of the charging requirements of the first electronic apparatus 20, the second electronic apparatus 30, the third electronic apparatus 40, and the fourth electronic apparatus 50, the microcontroller 102 transmits a charging menu to the first electronic apparatus 20, the second electronic apparatus 30, the third electronic apparatus 40, and the fourth electronic apparatus 50 respectively, wherein the charging menu may be adjusted based on the charging requirements.

Next, the first electronic apparatus 20, the second electronic apparatus 30, the third electronic apparatus 40, and the fourth electronic apparatus 50 each select a charging specification option from the charging menu and inform the microcontroller 102 of the charging specification option. Then, the microcontroller 102 controls the charging circuit 104 to charge the first electronic apparatus 20, the second electronic apparatus 30, the third electronic apparatus 40, and the fourth electronic apparatus 50 based on a plurality of the charging specification options and a charging capability maximum wattage value of the charging circuit 104.

In the following embodiment, it is assumed that the first charging specification power value 23 of the first electronic apparatus 20 is 80 watts, the second charging specification power value 33 of the second electronic apparatus 30 is 80 watts, the third charging specification power value 43 of the third electronic apparatus 40 is 80 watts, the fourth charging specification power value 53 of the fourth electronic apparatus 50 is 80 watts, and the charging capability maximum wattage value of the charging circuit 104 is 200 watts.

First, since the fourth electronic apparatus 50 is plugged into the priority charging port 108, the microcontroller 102 is aware of that the fourth electronic apparatus 50 is plugged into the priority charging port 108, so that the microcontroller 102 controls the charging circuit 104 to directly allocate a fourth allocated charging power value 136, which is equal to the fourth charging specification power value 53 of the fourth electronic apparatus 50, to the fourth electronic apparatus 50. In other words, the electronic apparatus plugged into the priority charging port 108 always retains the allocated charging power value which is equal to the charging specification power value. Therefore, the microcontroller 102 controls the charging circuit 104 to allocate 80 watts to the fourth electronic apparatus 50, so that the charging capacity of the charging circuit 104 has dropped to 120 watts.

There are various ways for the microcontroller 102 (and the user) to be aware of that the fourth electronic apparatus 50 is plugged into the priority charging port 108. For example, the microcontroller 102 may already be aware of the location of the priority charging port 108 in advance, and then characters or symbols (or a sticker) may be placed near the location of the priority charging port 108 on the housing of the multi-port output charging apparatus 10 to indicate that this charging port is the priority charging port, so that the user plugs the fourth electronic apparatus 50 into the priority charging port 108.

For another example, the present disclosure may also set other charging port as the priority charging port 108, or there may be no charging port designated as the priority charging port 108. Therefore, the multi-port output charging apparatus 10 further includes a first indicator light 138, a priority charging port switch button 140, a second indicator light 142, a third indicator light 146, and a fourth indicator light 150. The microcontroller 102 is electrically connected to the first indicator light 138, the priority charging port switch button 140, the second indicator light 142, the third indicator light 146, and the fourth indicator light 150. According to a number of times the priority charging port switch button 140 is pressed, the microcontroller 102 is configured to determine which charging port is the priority charging port 108 (namely, according to the number of times the priority charging port switch button 140 is pressed, the microcontroller 102 is configured to determine the priority charging port 108), and the corresponding indicator light may light up. For example, when the priority charging port switch button 140 is pressed for the first time, the microcontroller 102 determines that the first charging port from left to right in FIG. 1 is the priority charging port 108, and the microcontroller 102 drives the first indicator light 138 to light up. When the priority charging port switch button 140 is pressed for the second time, the microcontroller 102 determines that the second charging port from left to right in FIG. 1 is the priority charging port 108, and the microcontroller 102 drives the second indicator light 142 to light up. When the priority charging port switch button 140 is pressed for the third time, the microcontroller 102 determines that the third charging port from left to right in FIG. 1 is the priority charging port 108, and the microcontroller 102 drives the third indicator light 146 to light up. When the priority charging port switch button 140 is pressed for the fourth time, the microcontroller 102 determines that the fourth charging port from left to right in FIG. 1 is the priority charging port 108, and the microcontroller 102 drives the fourth indicator light 150 to light up. When the priority charging port switch button 140 is pressed for the fifth time, the microcontroller 102 determines that no charging port is the priority charging port 108, and the microcontroller 102 does not drive any indicator light. When the priority charging port switch button 140 is pressed for the sixth time, the microcontroller 102 determines that the first charging port from left to right in FIG. 1 is the priority charging port 108, and the microcontroller 102 drives the first indicator light 138 to light up. In this manner, the microcontroller 102 cyclically determines which charging port is the priority charging port 108, or determines that no charging port is the priority charging port 108. In the present disclosure, the location of the priority charging port 108 may be determined first before the electronic apparatuses are plugged into the charging ports. However, the present disclosure also allows for the electronic apparatuses to be plugged into the charging ports first, and then the location of the priority charging port 108 is determined, causing the multi-port output charging apparatus 10 to reallocate the power allocation, so that the electronic apparatus plugged into the charging port determined as the priority charging port 108 always retains the allocated charging power value which is equal to the charging specification power value. In another embodiment of the present disclosure, when an electronic apparatus is plugged into a charging port, the corresponding indicator light of that charging port lights up (for example, emitting green light). Then, when a charging port is selected as the priority charging port according to the number of times the priority charging port switch button 140 is pressed (as described above), the indicator light corresponding to the charging port selected as the priority charging port may change color accordingly (for example, from green to red) or change the illumination mode (for example, from constant light to flashing) to indicate that the charging port is selected as the priority charging port.

After the microcontroller 102 controls the charging circuit 104 to allocate 80 watts to the fourth electronic apparatus 50, the remaining charging capacity of the charging circuit 104 is 120 watts. Then, the microcontroller 102 controls the charging circuit 104 to allocate 120 watts (for example, evenly) to the first electronic apparatus 20, the second electronic apparatus 30, and the third electronic apparatus 40. Namely, for example, a first allocated charging power value 116 allocated to the first electronic apparatus 20 is 40 watts, a second allocated charging power value 124 allocated to the second electronic apparatus 30 is 40 watts, and a third allocated charging power value 134 allocated to the third electronic apparatus 40 is 40 watts.

The above content may be referred to as a first power allocation. Then, the microcontroller 102 controls the charging circuit 104 to charge the electronic apparatuses based on the maximum capacity values of the first power allocation mentioned above. Namely, the microcontroller 102 controls the charging circuit 104 to charge the fourth electronic apparatus 50 with 80 watts, the microcontroller 102 controls the charging circuit 104 to charge the first electronic apparatus 20 with 40 watts, the microcontroller 102 controls the charging circuit 104 to charge the second electronic apparatus 30 with 40 watts, and the microcontroller 102 controls the charging circuit 104 to charge the third electronic apparatus 40 with 40 watts.

Then, the following content may be referred to as a second power allocation. The current detection circuit 110 is configured to detect a first charging current 112 provided by the charging circuit 104 to charge the first electronic apparatus 20, and inform the microcontroller 102 of a first charging current value 126 of the first charging current 112. At the same time, the current detection circuit 110 is configured to detect a second charging current 114 provided by the charging circuit 104 to charge the second electronic apparatus 30, and inform the microcontroller 102 of a second charging current value 128 of the second charging current 114; the current detection circuit 110 is configured to detect a third charging current 130 provided by the charging circuit 104 to charge the third electronic apparatus 40, and inform the microcontroller 102 of a third charging current value 132 of the third charging current 130.

Next, the microcontroller 102 is configured to calculate a first actual average charging power value 25 of the first electronic apparatus 20 based on a plurality of the first charging current values 126 within a predetermined time (for example, one minute to three minutes). At the same time, the microcontroller 102 is configured to calculate a second actual average charging power value 35 of the second electronic apparatus 30 based on a plurality of the second charging current values 128 within the predetermined time; the microcontroller 102 is configured to calculate a third actual average charging power value 45 of the third electronic apparatus 40 based on a plurality of the third charging current values 132 within the predetermined time. Moreover, since the charging current values are known, and the charging voltage values are also obtained by the microcontroller 102 through the initial communication with the electronic apparatuses mentioned above (or from a voltage detector not shown in FIG. 1 to obtain the charging voltage values, or the microcontroller 102 may necessarily be aware of the charging voltage values through the charging circuit 104), thus the charging power values may be calculated (wherein power equals current multiplied by voltage).

For the sake of explanation, it is assumed that the first actual average charging power value 25 is less than a first predetermined percentage of the first allocated charging power value 116 allocated by the charging circuit 104 to the first electronic apparatus 20; the second actual average charging power value 35 is greater than or equal to the first predetermined percentage of the second allocated charging power value 124 allocated by the charging circuit 104 to the second electronic apparatus 30; the third actual average charging power value 45 is greater than or equal to the first predetermined percentage of the third allocated charging power value 134 allocated by the charging circuit 104 to the third electronic apparatus 40.

For example, the first actual average charging power value 25 is 10 watts, the first allocated charging power value 116 is 40 watts, the first predetermined percentage is 60%, and then the first actual average charging power value 25 (10 watts) is less than the first predetermined percentage of the first allocated charging power value 116 (40 watts multiplied by 60% equals 24 watts). The second actual average charging power value 35 is 30 watts, the second allocated charging power value 124 is 40 watts, and then the second actual average charging power value 35 (30 watts) is greater than the first predetermined percentage of the second allocated charging power value 124 (40 watts multiplied by 60% equals 24 watts). The third actual average charging power value 45 is 30 watts, the third allocated charging power value 134 is 40 watts, and then the third actual average charging power value 45 (30 watts) is greater than the first predetermined percentage of the third allocated charging power value 134 (40 watts multiplied by 60% equals 24 watts).

Based on the above embodiment, it appears that the first electronic apparatus 20 may be nearly fully charged, so the present disclosure reallocates a portion of the first allocated charging power value 116 to the second electronic apparatus 30 and the third electronic apparatus 40, as described below.

It is assumed that the second allocated charging power value 124 allocated by the charging circuit 104 to the second electronic apparatus 30 is less than the second charging specification power value 33 of the second electronic apparatus 30, and the third allocated charging power value 134 allocated by the charging circuit 104 to the third electronic apparatus 40 is less than the third charging specification power value 43 of the third electronic apparatus 40. For example, the second allocated charging power value 124 is 40 watts, and the second charging specification power value 33 is 80 watts, so that the second allocated charging power value 124 (40 watts) is less than the second charging specification power value 33 (80 watts); the third allocated charging power value 134 is 40 watts, and the third charging specification power value 43 is 80 watts, so that the third allocated charging power value 134 (40 watts) is less than the third charging specification power value 43 (80 watts).

The microcontroller 102 is configured to subtract the first actual average charging power value 25 (for example, 10 watts) from the first allocated charging power value 116 (for example, 40 watts) to obtain an idle power value 118 (for example, 30 watts), and multiply the idle power value 118 by a second predetermined percentage (for example, 80%) to obtain an allocating power value 122 (for example, 24 watts), and allocate the allocating power value 122 to a power sharing pool 120, and allocate the allocating power value 122 to the second electronic apparatus 30 and the third electronic apparatus 40 via the charging circuit 104.

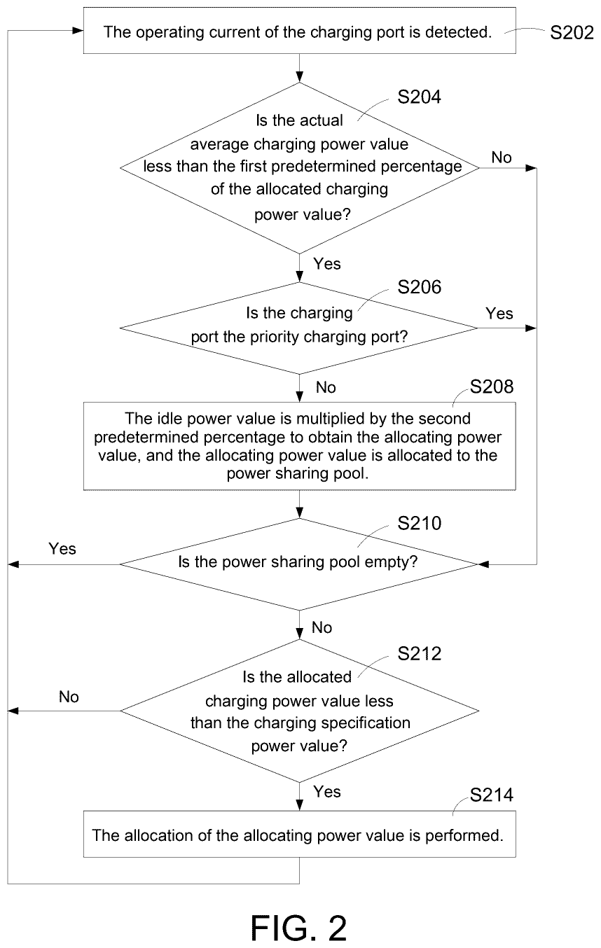

Please also refer to FIG. 2 to better understand the above content. FIG. 2 shows a flowchart of the operating method (also referred to as a full-time dynamic power allocation method) of the multi-port output charging apparatus 10 of the present disclosure. Please also refer to FIG. 1. The operation method of the multi-port output charging apparatus 10 of the present disclosure includes the following steps:
Step S202: The operating current (namely, the charging current) of the charging port is detected. This step is performed by the current detection circuit 110 to detect the first charging current 112, the second charging current 114, and the third charging current 130. Then, the operation method of the present disclosure proceeds to step S204, so the information of the first electronic apparatus 20, the second electronic apparatus 30, and the third electronic apparatus 40 is sent into step S204.
Step S204: Is the actual average charging power value less than the first predetermined percentage of the allocated charging power value? This step is performed by the microcontroller 102 to determine: whether the first actual average charging power value 25 is less than the first predetermined percentage of the first allocated charging power value 116, and whether the second actual average charging power value 35 is less than the first predetermined percentage of the second allocated charging power value 124, and whether the third actual average charging power value 45 is less than the first predetermined percentage of the third allocated charging power value 134. If the actual average charging power value is less than the first predetermined percentage of the allocated charging power value, the operation method of the present disclosure proceeds to step S206, so the information of the first electronic apparatus 20 is sent to step S206. If the actual average charging power value is not less than the first predetermined percentage of the allocated charging power value, the operation method of the present disclosure proceeds to step S210, so the information of the second electronic apparatus 30 and the third electronic apparatus 40 is sent to step S210.
Step S206: Is the charging port the priority charging port? This step is confirmed by the microcontroller 102. If the charging port is the priority charging port, the operation method of the present disclosure proceeds to step S210. If the charging port is not the priority charging port, the operation method of the present disclosure proceeds to step S208, so the information of the first electronic apparatus 20 is sent to step S208. The charging current of the fourth electronic apparatus 50 may also be detected in step S202. However, if the information of the fourth electronic apparatus 50 is eventually sent to step S212, the information of the fourth electronic apparatus 50 is inevitably sent back to step S202. Alternatively, if the information of the fourth electronic apparatus 50 is sent to step S206, the information of the fourth electronic apparatus 50 is also inevitably sent back to step S202. Therefore, the purpose of step S206 is to confirm again whether the charging port is the priority charging port.
Step S208: The idle power value is multiplied by the second predetermined percentage to obtain the allocating power value, and the allocating power value is allocated to the power sharing pool. This step is performed by the microcontroller 102, to multiply the idle power value 118 by the second predetermined percentage to obtain the allocating power value 122, and to allocate the allocating power value 122 to the power sharing pool 120. Then, the operation method of the present disclosure proceeds to step S210.
Step S210: Is the power sharing pool empty? This step is confirmed by the microcontroller 102. If the power sharing pool is empty, the operation method of the present disclosure returns to step S202. If the power sharing pool is not empty, the operation method of the present disclosure proceeds to step S212, so the information of the second electronic apparatus 30 and the third electronic apparatus 40 is sent to step S212.
Step S212: Is the allocated charging power value less than the charging specification power value? This step is performed by the microcontroller 102 to determine: whether the second allocated charging power value 124 is less than the second charging specification power value 33, and whether the third allocated charging power value 134 is less than the third charging specification power value 43. If the allocated charging power value is less than the charging specification power value, the operation method of the present disclosure proceeds to step S214, so the information of the second electronic apparatus 30 and the third electronic apparatus 40 is sent to step S214. If the allocated charging power value is not less than the charging specification power value, the operation method of the present disclosure returns to step S202.
Step S214: The allocation of the allocating power value is performed. Then, the operation method of the present disclosure returns to step S202. In step S214, the present disclosure provides multiple ways to perform the allocation of the allocating power value, as detailed below.

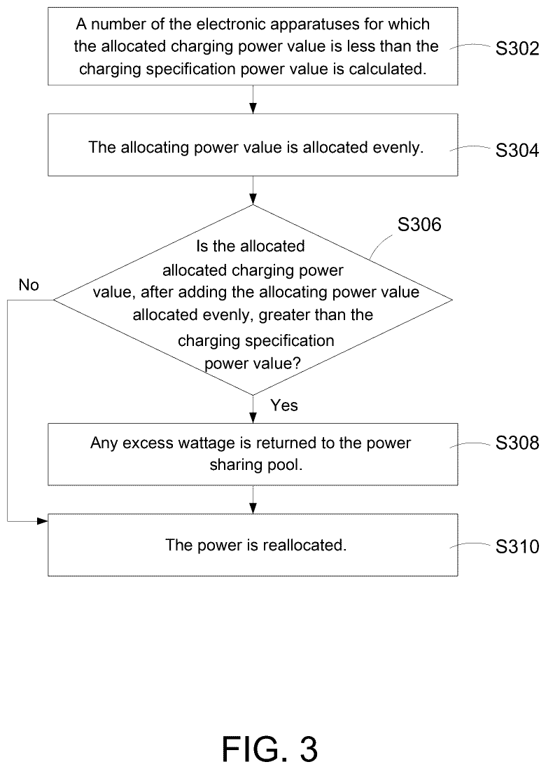

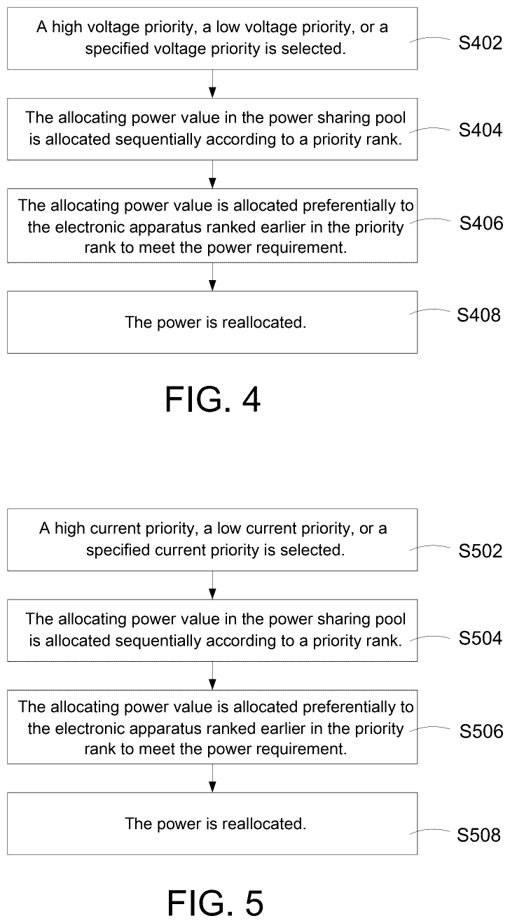

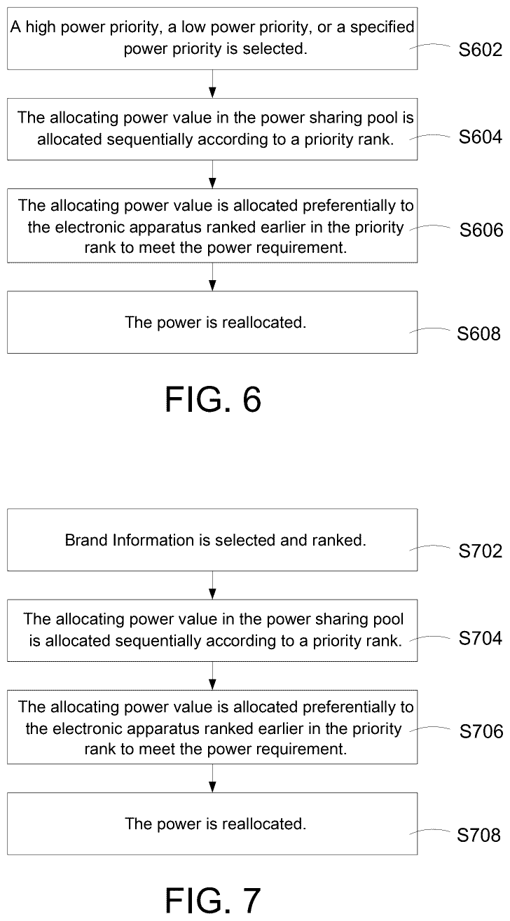

The microcontroller 102 is configured to allocate the allocating power value 122 evenly to the second electronic apparatus 30 and the third electronic apparatus 40 via the charging circuit 104; alternatively, based on the charging voltage specifications (namely, the second charging specification voltage value 31 and the third charging specification voltage value 41), the charging current specifications (namely, the second charging specification current value 32 and the third charging specification current value 42), the charging power specifications (namely, the second charging specification power value 33 and the third charging specification power value 43), or the brands (namely, the second brand information 34 and the third brand information 44) of the second electronic apparatus 30 and the third electronic apparatus 40, the microcontroller 102 is configured to allocate the allocating power value 122 to the second electronic apparatus 30 and the third electronic apparatus 40 via the charging circuit 104. Namely, the present disclosure may select one of the following methods to perform step S214 in FIG. 2: the average allocation method (FIG. 3), the allocation method based on charging voltage specifications (FIG. 4), the allocation method based on charging current specifications (FIG. 5), the allocation method based on charging power specifications (FIG. 6), and the allocation method based on brand information (FIG. 7). The details are as follows.

FIG. 3 shows a flowchart of the average allocation method of the allocating power value 122 of the present disclosure. Please also refer to FIG. 1 and FIG. 2. The average allocation method for the allocating power value 122 of the present disclosure includes the following steps:
Step S302: A number of the electronic apparatuses for which the allocated charging power value is less than the charging specification power value is calculated. This step is performed by the microcontroller 102 to calculate the number of the electronic apparatuses (namely, two) corresponding to the second electronic apparatus 30 and the third electronic apparatus 40. Then, the average allocation method of the present disclosure proceeds to step S304, so the information of the second electronic apparatus 30 and the third electronic apparatus 40 is sent to step S304.
Step S304: The allocating power value is allocated evenly. This step is performed by the microcontroller 102 to evenly allocate the allocating power value 122 to the second electronic apparatus 30 and the third electronic apparatus 40. Then, the average allocation method of the present disclosure proceeds to step S306, so the information of the second electronic apparatus 30 and the third electronic apparatus 40 is sent to step S306.
Step S306: Is the allocated charging power value, after adding the allocating power value allocated evenly, greater than the charging specification power value? This step is performed by the microcontroller 102 to determine: whether the second allocated charging power value 124, after adding the allocating power value 122 allocated evenly, is greater than the second charging specification power value 33, and whether the third allocated charging power value 134, after adding the allocating power value 122 allocated evenly, is greater than the third charging specification power value 43. If the allocated charging power value, after adding the allocating power value 122 allocated evenly, is not greater than the charging specification power value, then the average allocation method of the present disclosure proceeds to step S310, so the information of the second electronic apparatus 30 and the third electronic apparatus 40 is sent to step S310. If the allocated charging power value, after adding the allocating power value 122 allocated evenly, is greater than the charging specification power value, then the average allocation method of the present disclosure proceeds to step S308.
Step S308: Any excess wattage is returned to the power sharing pool. This step is performed by the microcontroller 102. It is reassumed that in step S306, the third allocated charging power value 134, after adding the allocating power value 122 allocated evenly, is greater than the third charging specification power value 43, and then the microcontroller 102 may subtract the third charging specification power value 43 from the third allocated charging power value 134 (after adding the allocating power value 122 allocated evenly) to obtain an excess power value, which then is returned to the power sharing pool 120. Next, the average allocation method of the present disclosure proceeds to step S310.
Step S310: The power is reallocated. Namely, the microcontroller 102 is configured to subtract the allocating power value 122 from the first allocated charging power value 116 to obtain a first reallocated charging power value, which is then allocated to the first electronic apparatus 20, wherein the power value obtained by subtracting the first actual average charging power value 25 from the first reallocated charging power value is used as a buffer for the dynamic load of the first electronic apparatus 20. The microcontroller 102 is configured to add the allocating power value 122 allocated evenly to the second allocated charging power value 124 to obtain a second reallocated charging power value, which is then allocated to the second electronic apparatus 30. If the third allocated charging power value 134, after adding the allocating power value 122 allocated evenly, is not greater than the third charging specification power value 43, the microcontroller 102 is configured to allocate a third reallocated charging power value, which is a sum of the third allocated charging power value 134 and the allocating power value 122 allocated evenly, to the third electronic apparatus 40. If the third allocated charging power value 134, after adding the allocating power value 122 allocated evenly, is greater than the third charging specification power value 43, the microcontroller 102 is configured to allocate a third reallocated charging power value equal to the third charging specification power value 43 to the third electronic apparatus 40. Finally, the average allocation method of the present disclosure is completed.

FIG. 4 shows a flowchart of the allocation method of the allocating power value 122 based on the charging voltage specifications of the present disclosure. Please also refer to FIG. 1 and FIG. 2. The allocation method of the allocating power value 122 based on the charging voltage specifications of the present disclosure includes the following steps:
Step S402: A high voltage priority, a low voltage priority, or a specified voltage priority is selected. Then, the allocation method based on the charging voltage specifications of the present disclosure proceeds to step S404.
Step S404: The allocating power value in the power sharing pool is allocated sequentially according to a priority rank. Then, the allocation method based on the charging voltage specifications of the present disclosure proceeds to step S406.
Step S406: The allocating power value is allocated preferentially to the electronic apparatus ranked earlier in the priority rank to meet the power requirement. Then, the allocation method based on the charging voltage specifications of the present disclosure proceeds to step S408.

Namely, in steps S402, S404, and S406, the microcontroller 102 sorts the second electronic apparatus 30 and the third electronic apparatus 40 based on either the higher voltage, the lower voltage, or the specified voltage from the second charging specification voltage value 31 and the third charging specification voltage value 41. The allocating power value 122 is then preferentially allocated to the second electronic apparatus 30 or the third electronic apparatus 40, whichever comes first in the priority rank, in order to meet the second charging specification power value 33 or the third charging specification power value 43.
Step S408: The power is reallocated. The content of this step is similar to that of the aforementioned step S310, and is therefore not repeated here. Finally, the allocation method based on the charging voltage specifications of the present disclosure is completed.

FIG. 5 shows a flowchart of the allocation method of the allocating power value 122 based on the charging current specifications of the present disclosure. Please also refer to FIG. 1 and FIG. 2. The allocation method of the allocating power value 122 based on the charging current specifications of the present disclosure includes the following steps:
Step S502: A high current priority, a low current priority, or a specified current priority is selected. Then, the allocation method based on the charging current specifications of the present disclosure proceeds to step S504.
Step S504: The allocating power value in the power sharing pool is allocated sequentially according to a priority rank. Then, the allocation method based on the charging current specifications of the present disclosure proceeds to step S506.
Step S506: The allocating power value is allocated preferentially to the electronic apparatus ranked earlier in the priority rank to meet the power requirement. Then, the allocation method based on the charging current specifications of the present disclosure proceeds to step S508.

Namely, in steps S502, S504, and S506, the microcontroller 102 sorts the second electronic apparatus 30 and the third electronic apparatus 40 based on either the higher current, the lower current, or the specified current from the second charging specification current value 32 and the third charging specification current value 42. The allocating power value 122 is then preferentially allocated to the second electronic apparatus 30 or the third electronic apparatus 40, whichever comes first in the priority rank, in order to meet the second charging specification power value 33 or the third charging specification power value 43.
Step S508: The power is reallocated. The content of this step is similar to that of the aforementioned step S310, and is therefore not repeated here. Finally, the allocation method based on the charging current specifications of the present disclosure is completed.

FIG. 6 shows a flowchart of the allocation method of the allocating power value based on the charging power specifications of the present disclosure, which includes the following steps:
Step S602: A high power priority, a low power priority, or a specified power priority is selected.
Step S604: The allocating power value in the power sharing pool is allocated sequentially according to a priority rank.
Step S606: The allocating power value is allocated preferentially to the electronic apparatus ranked earlier in the priority rank to meet the power requirement.

Namely, in steps S602, S604, and S606, the microcontroller 102 sorts the second electronic apparatus 30 and the third electronic apparatus 40 based on either the higher power, the lower power, or the specified power from the second charging specification power value 33 and the third charging specification power value 43. The allocating power value 122 is then preferentially allocated to the second electronic apparatus 30 or the third electronic apparatus 40, whichever comes first in the priority rank, in order to meet the second charging specification power value 33 or the third charging specification power value 43.
Step S608: The power is reallocated.

FIG. 7 shows a flowchart of the allocation method of the allocating power value 122 based on the brand information (for example, Apple Computer Company, Hewlett-Packard Company, and so on) of the present disclosure. Please also refer to FIG. 1 and FIG. 2. The allocation method of the allocating power value 122 based on the brand information includes the following steps:
Step S702: Brand Information is selected and ranked. Then, the allocation method based on the brand information of the present disclosure proceeds to step S704.
Step S704: The allocating power value in the power sharing pool is allocated sequentially according to a priority rank. Then, the allocation method based on the brand information of the present disclosure proceeds to step S706.
Step S706: The allocating power value is allocated preferentially to the electronic apparatus ranked earlier in the priority rank to meet the power requirement. Then, the allocation method based on the brand information of the present disclosure proceeds to step S708.

Namely, in steps S702, S704, and S706, the microcontroller 102 sorts the second electronic apparatus 30 and the third electronic apparatus 40 based on the second brand information 34 and the third brand information 44. The allocating power value 122 is then preferentially allocated to the second electronic apparatus 30 or the third electronic apparatus 40, whichever comes first in the priority rank, in order to meet the second charging specification power value 33 or the third charging specification power value 43.
Step S708: The power is reallocated. The content of this step is similar to that of the aforementioned step S310, and is therefore not repeated here. Finally, the allocation method based on the brand information of the present disclosure is completed.

In an embodiment of the present disclosure, the aforementioned second power allocation may be repeated, which is referred to as multiple power allocations. Through the optimization method of the second power allocation, the multi-port output charging apparatus 10 may charge multiple electronic apparatuses at the maximum output power specification at all times, significantly reducing the time required to fully charge multiple electronic apparatuses. If the multi-port output charging apparatus 10 detects an electronic apparatus which is not power delivery (PD) compatible plugged into the multi-port output charging apparatus 10, the multi-port output charging apparatus 10 may exclude this electronic apparatus from participating in the aforementioned second power allocation (namely, the full-time dynamic power allocation method). For example, if an electronic apparatus with a Type-C female to Type-A female is connected, the power may not be allocated to the power sharing pool 120, or the electronic apparatus is unable to be charged when plugged into the multi-port output charging apparatus 10. In this case, the multi-port output charging apparatus 10 may charge the non-PD electronic apparatus at 5 volts and 3 amperes.

In the aforementioned embodiment of the first power allocation, 120 watts are evenly allocated to the first electronic apparatus 20, the second electronic apparatus 30, and the third electronic apparatus 40. However, the following content may disclose a more detailed embodiment of the first power allocation. In this more detailed embodiment, it is assumed that the charging capability maximum wattage value of the charging circuit 104 is 160 watts, and the charging specification power values of the four electronic apparatuses are 140 watts, 65 watts, 45 watts, and 27 watts, respectively. Therefore, the total of the charging specification power values of the four electronic apparatuses is 277 watts (namely, 140+65+45+27=277). As a result, the allocated charging power values allocated by the present disclosure to the four electronic apparatuses based on the ratio may be approximately 80 watts (namely, 160*(140/277)), 37 watts (namely, 160*(65/277)), 25 watts (namely, 160*(45/277)), and 15 watts (namely, 160*(27/277)). In the first power allocation of the multi-port output charging apparatus 10, the charging circuit 104 is configured to allocate the fourth allocated charging power value 136 equal to the fourth charging specification power value 53 of the fourth electronic apparatus 50 to the fourth electronic apparatus 50 (because the fourth electronic apparatus 50 is plugged into the priority charging port 108). In the first power allocation of the multi-port output charging apparatus 10, the charging circuit 104 is configured to set the first allocated charging power value 116 of the first electronic apparatus 20, the second allocated charging power value 124 of the second electronic apparatus 30, and the third allocated charging power value 134 of the third electronic apparatus 40, based on a ratio among the first charging specification power value 23 of the first electronic apparatus 20, the second charging specification power value 33 of the second electronic apparatus 30, and the third charging specification power value 43 of the third electronic apparatus 40, using a remaining power value obtained by subtracting the fourth allocated charging power value 136 from a charging capability maximum wattage value of the charging circuit 104, or, the charging circuit 104 is configured to set the first allocated charging power value 116 of the first electronic apparatus 20, the second allocated charging power value 124 of the second electronic apparatus 30, and the third allocated charging power value 134 of the third electronic apparatus 40, based on the charging voltage specifications (namely, the first charging specification voltage value 21, the second charging specification voltage value 31, and the third charging specification voltage value 41), the charging current specifications (namely, the first charging specification current value 22, the second charging specification current value 32, and the third charging specification current value 42), the charging power specifications (namely, the first charging specification power value 23, the second charging specification power value 33, and the third charging specification power value 43), or the brands (namely, the first brand information 24, the second brand information 34, and the third brand information 44) of the first electronic apparatus 20, the second electronic apparatus 30, and the third electronic apparatus 40, using the remaining power value obtained by subtracting the fourth allocated charging power value 136 from the charging capability maximum wattage value of the charging circuit 104.

In the aforementioned embodiment, since the second allocated charging power value 124 allocated by the charging circuit 104 to the second electronic apparatus 30 is less than the second charging specification power value 33 of the second electronic apparatus 30, the second allocated charging power value 124 of the second electronic apparatus 30 is increased during the second power allocation. However, the present disclosure is not limited to this. In another embodiment of the present disclosure, the condition under which the allocated charging power value of an electronic apparatus may increase during the second power allocation is when a ratio of the actual average charging power value to the allocated charging power value is greater than a specific percentage. For example, if the actual average charging power value of the electronic apparatus is 48 watts and the allocated charging power value is 50 watts and the specific percentage is set to 80%, then the ratio of the actual average charging power value to the allocated charging power value is greater than the specific percentage (namely, 48/50=0.96>80%); therefore, during the second power allocation, the allocated charging power value of the electronic apparatus may be increased. In the same example, if the actual average charging power value is only 35 watts, then the ratio of the actual average charging power value to the allocated charging power value is less than the specific percentage (namely, 35/50 0.7<80%); therefore, during the second power allocation, the allocated charging power value of the electronic apparatus may not be increased.

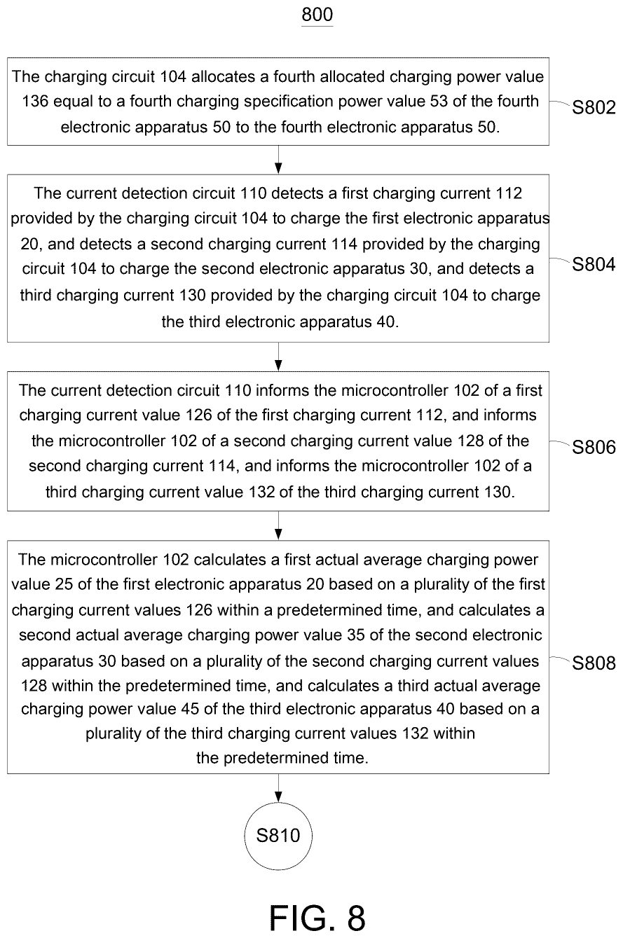

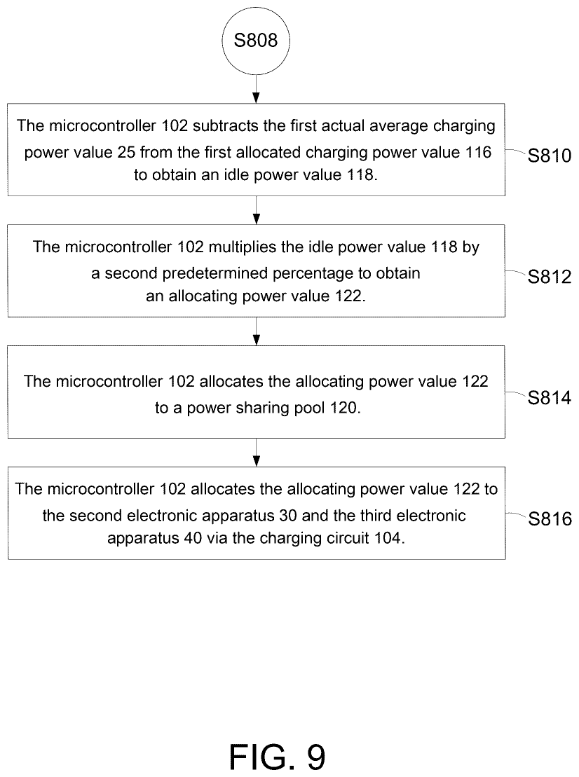

FIG. 8 shows a flowchart of a part of the full-time dynamic power allocation method 800 of the present disclosure. FIG. 9 shows a flowchart of another part of the full-time dynamic power allocation method 800 of the present disclosure. Please also refer to FIG. 1. The full-time dynamic power allocation method 800 of the present disclosure is applied to a multi-port output charging apparatus 10, a first electronic apparatus 20, a second electronic apparatus 30, a third electronic apparatus 40, and a fourth electronic apparatus 50. The multi-port output charging apparatus 10 includes a microcontroller 102, a charging circuit 104, a current detection circuit 110, a plurality of common charging ports 106, and a priority charging port 108. The first electronic apparatus 20, the second electronic apparatus 30, and the third electronic apparatus 40 are plugged into the common charging ports 106. The fourth electronic apparatus 50 is plugged into the priority charging port 108. The full-time dynamic power allocation method 800 includes the following steps:
Step S802: The charging circuit 104 allocates a fourth allocated charging power value 136 equal to a fourth charging specification power value 53 of the fourth electronic apparatus 50 to the fourth electronic apparatus 50. Then, the full-time dynamic power allocation method 800 of the present disclosure proceeds to step S804.
Step S804: The current detection circuit 110 detects a first charging current 112 provided by the charging circuit 104 to charge the first electronic apparatus 20, and detects a second charging current 114 provided by the charging circuit 104 to charge the second electronic apparatus 30, and detects a third charging current 130 provided by the charging circuit 104 to charge the third electronic apparatus 40. Then, the full-time dynamic power allocation method 800 of the present disclosure proceeds to step S806.
Step S806: The current detection circuit 110 informs the microcontroller 102 of a first charging current value 126 of the first charging current 112, and informs the microcontroller 102 of a second charging current value 128 of the second charging current 114, and informs the microcontroller 102 of a third charging current value 132 of the third charging current 130. Then, the full-time dynamic power allocation method 800 of the present disclosure proceeds to step S808.
Step S808: The microcontroller 102 calculates a first actual average charging power value 25 of the first electronic apparatus 20 based on a plurality of the first charging current values 126 within a predetermined time, and calculates a second actual average charging power value 35 of the second electronic apparatus 30 based on a plurality of the second charging current values 128 within the predetermined time, and calculates a third actual average charging power value 45 of the third electronic apparatus 40 based on a plurality of the third charging current values 132 within the predetermined time. Moreover, the first actual average charging power value 25 is less than a first predetermined percentage of a first allocated charging power value 116 allocated by the charging circuit 104 to the first electronic apparatus 20. A second allocated charging power value 124 allocated by the charging circuit 104 to the second electronic apparatus 30 is less than a second charging specification power value 33 of the second electronic apparatus 30. A third allocated charging power value 134 allocated by the charging circuit 104 to the third electronic apparatus 40 is less than a third charging specification power value 43 of the third electronic apparatus 40. Then, the full-time dynamic power allocation method 800 of the present disclosure proceeds to step S810.
Step S810: The microcontroller 102 subtracts the first actual average charging power value 25 from the first allocated charging power value 116 to obtain an idle power value 118. Then, the full-time dynamic power allocation method 800 of the present disclosure proceeds to step S812.
Step S812: The microcontroller 102 multiplies the idle power value 118 by a second predetermined percentage to obtain an allocating power value 122. Then, the full-time dynamic power allocation method 800 of the present disclosure proceeds to step S814.
Step S814: The microcontroller 102 allocates the allocating power value 122 to a power sharing pool 120. Then, the full-time dynamic power allocation method 800 of the present disclosure proceeds to step S816.
Step S816: The microcontroller 102 allocates the allocating power value 122 to the second electronic apparatus 30 and the third electronic apparatus 40 via the charging circuit 104.

Moreover, step S816 mentioned above may be that: the microcontroller 102 allocates the allocating power value 122 evenly to the second electronic apparatus 30 and the third electronic apparatus 40 via the charging circuit 104, or, based on the charging voltage specifications, the charging current specifications, the charging power specifications, or the brands of the second electronic apparatus 30 and the third electronic apparatus 40, the microcontroller 102 allocates the allocating power value 122 to the second electronic apparatus 30 and the third electronic apparatus 40 via the charging circuit 104. In a first power allocation of the multi-port output charging apparatus 10, the charging circuit 104 is configured to allocate the fourth allocated charging power value 136 equal to the fourth charging specification power value 53 of the fourth electronic apparatus 50 to the fourth electronic apparatus 50. In the first power allocation of the multi-port output charging apparatus 10, the charging circuit 104 is configured to set the first allocated charging power value 116 of the first electronic apparatus 20, the second allocated charging power value 124 of the second electronic apparatus 30, and the third allocated charging power value 134 of the third electronic apparatus 40, based on a ratio among a first charging specification power value 23 of the first electronic apparatus 20, a second charging specification power value 33 of the second electronic apparatus 30, and a third charging specification power value 43 of the third electronic apparatus 40, using a remaining power value obtained by subtracting the fourth allocated charging power value 136 from a charging capability maximum wattage value of the charging circuit 104, or, the charging circuit 104 is configured to set the first allocated charging power value 116 of the first electronic apparatus 20, the second allocated charging power value 124 of the second electronic apparatus 30, and the third allocated charging power value 134 of the third electronic apparatus 40, based on the charging voltage specifications (namely, the first charging specification voltage value 21, the second charging specification voltage value 31, and the third charging specification voltage value 41), the charging current specifications (namely, the first charging specification current value 22, the second charging specification current value 32, and the third charging specification current value 42), the charging power specifications (namely, the first charging specification power value 23, the second charging specification power value 33, and the third charging specification power value 43), or the brands (namely, the first brand information 24, the second brand information 34, and the third brand information 44) of the first electronic apparatus 20, the second electronic apparatus 30, and the third electronic apparatus 40, using the remaining power value obtained by subtracting the fourth allocated charging power value 136 from the charging capability maximum wattage value of the charging circuit 104.

The remaining content of the full-time dynamic power allocation method 800 of the present disclosure is the same as the previously disclosed content of the multi-port output charging apparatus 10 of the present disclosure, and therefore may not be repeated here.

The advantage of the present disclosure is to reduce the charging time for multiple electronic apparatuses connected to the multi-port output charging apparatus.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. A multi-port output charging apparatus, applied to a first electronic apparatus and a second electronic apparatus, the multi-port output charging apparatus comprising:
a microcontroller;
a charging circuit, electrically connected to the microcontroller; and
a current detection circuit, electrically connected to the microcontroller,
wherein the current detection circuit is configured to detect a first charging current provided by the charging circuit to charge the first electronic apparatus, and inform the microcontroller of a first charging current value of the first charging current; the microcontroller is configured to calculate a first actual average charging power value of the first electronic apparatus based on a plurality of the first charging current values within a predetermined time; the first actual average charging power value is less than a first allocated charging power value allocated by the charging circuit to the first electronic apparatus;
wherein the current detection circuit is configured to detect a second charging current provided by the charging circuit to charge the second electronic apparatus, and inform the microcontroller of a second charging current value of the second charging current; the microcontroller is configured to calculate a second actual average charging power value of the second electronic apparatus based on a plurality of the second charging current values within the predetermined time; a second allocated charging power value allocated by the charging circuit to the second electronic apparatus is less than a second charging specification power value of the second electronic apparatus;
wherein the microcontroller is configured to subtract the first actual average charging power value from the first allocated charging power value to obtain an idle power value, and multiply the idle power value by a second predetermined percentage to obtain an allocating power value, and allocate the allocating power value to a power sharing pool, and allocate at least a portion of the allocating power value to the second electronic apparatus via the charging circuit.

2. The multi-port output charging apparatus of the claim 1, further applied to a third electronic apparatus, wherein the current detection circuit is configured to detect a third charging current provided by the charging circuit to charge the third electronic apparatus, and inform the microcontroller of a third charging current value of the third charging current; the microcontroller is configured to calculate a third actual average charging power value of the third electronic apparatus based on a plurality of the third charging current values within the predetermined time; a third allocated charging power value allocated by the charging circuit to the third electronic apparatus is less than a third charging specification power value of the third electronic apparatus;
wherein the microcontroller is configured to allocate the allocating power value to the second electronic apparatus and the third electronic apparatus via the charging circuit.

3. The multi-port output charging apparatus of the claim 2, wherein the microcontroller is configured to allocate the allocating power value evenly to the second electronic apparatus and the third electronic apparatus via the charging circuit, or, based on charging voltage specifications, charging current specifications, charging power specifications, or brands of the second electronic apparatus and the third electronic apparatus, the microcontroller is configured to allocate the allocating power value to the second electronic apparatus and the third electronic apparatus via the charging circuit.

4. The multi-port output charging apparatus of the claim 3, further applied to a fourth electronic apparatus, the multi-port output charging apparatus further comprising:
a plurality of common charging ports, electrically connected to the microcontroller and the charging circuit, wherein the first electronic apparatus, the second electronic apparatus, and the third electronic apparatus are plugged into the common charging ports; and
a priority charging port, electrically connected to the microcontroller and the charging circuit, wherein the fourth electronic apparatus is plugged into the priority charging port,
wherein the charging circuit is configured to allocate a fourth allocated charging power value equal to a fourth charging specification power value of the fourth electronic apparatus to the fourth electronic apparatus.

5. The multi-port output charging apparatus of the claim 4, wherein in a first power allocation of the multi-port output charging apparatus, the charging circuit is configured to allocate the fourth allocated charging power value equal to the fourth charging specification power value of the fourth electronic apparatus to the fourth electronic apparatus;
wherein in the first power allocation of the multi-port output charging apparatus, the charging circuit is configured to set the first allocated charging power value of the first electronic apparatus, the second allocated charging power value of the second electronic apparatus, and the third allocated charging power value of the third electronic apparatus, based on a ratio among a first charging specification power value of the first electronic apparatus, the second charging specification power value of the second electronic apparatus, and the third charging specification power value of the third electronic apparatus, using a remaining power value obtained by subtracting the fourth allocated charging power value from a charging capability maximum wattage value of the charging circuit, or, the charging circuit is configured to set the first allocated charging power value of the first electronic apparatus, the second allocated charging power value of the second electronic apparatus, and the third allocated charging power value of the third electronic apparatus, based on the charging voltage specifications, the charging current specifications, the charging power specifications, or the brands of the first electronic apparatus, the second electronic apparatus, and the third electronic apparatus, using the remaining power value obtained by subtracting the fourth allocated charging power value from the charging capability maximum wattage value of the charging circuit.

6. A full-time dynamic power allocation method, applied to a multi-port output charging apparatus, a first electronic apparatus, and a second electronic apparatus, the multi-port output charging apparatus comprising a microcontroller, a charging circuit, and a current detection circuit, the full-time dynamic power allocation method comprising:
detecting, by the current detection circuit, a first charging current provided by the charging circuit to charge the first electronic apparatus;
informing, by the current detection circuit, the microcontroller of a first charging current value of the first charging current;
calculating, by the microcontroller, a first actual average charging power value of the first electronic apparatus based on a plurality of the first charging current values within a predetermined time, wherein the first actual average charging power value is less than a first allocated charging power value allocated by the charging circuit to the first electronic apparatus;
detecting, by the current detection circuit, a second charging current provided by the charging circuit to charge the second electronic apparatus;
informing, by the current detection circuit, the microcontroller of a second charging current value of the second charging current;
calculating, by the microcontroller, a second actual average charging power value of the second electronic apparatus based on a plurality of the second charging current values within the predetermined time, wherein a second allocated charging power value allocated by the charging circuit to the second electronic apparatus is less than a second charging specification power value of the second electronic apparatus;
subtracting, by the microcontroller, the first actual average charging power value from the first allocated charging power value to obtain an idle power value;
multiplying, by the microcontroller, the idle power value by a second predetermined percentage to obtain an allocating power value;
allocating, by the microcontroller, the allocating power value to a power sharing pool; and
allocating, by the microcontroller, at least a portion of the allocating power value to the second electronic apparatus via the charging circuit.

7. The full-time dynamic power allocation method of the claim 6, further applied to a third electronic apparatus, the full-time dynamic power allocation method further comprising:
detecting, by the current detection circuit, a third charging current provided by the charging circuit to charge the third electronic apparatus;
informing, by the current detection circuit, the microcontroller of a third charging current value of the third charging current;
calculating, by the microcontroller, a third actual average charging power value of the third electronic apparatus based on a plurality of the third charging current values within the predetermined time, wherein a third allocated charging power value allocated by the charging circuit to the third electronic apparatus is less than a third charging specification power value of the third electronic apparatus; and
allocating, by the microcontroller, the allocating power value to the second electronic apparatus and the third electronic apparatus via the charging circuit.

8. The full-time dynamic power allocation method of the claim 7, wherein allocating, by the microcontroller, the allocating power value to the second electronic apparatus and the third electronic apparatus via the charging circuit is: allocating, by the microcontroller, the allocating power value evenly to the second electronic apparatus and the third electronic apparatus via the charging circuit, or, allocating, by the microcontroller, the allocating power value to the second electronic apparatus and the third electronic apparatus via the charging circuit based on charging voltage specifications, charging current specifications, charging power specifications, or brands of the second electronic apparatus and the third electronic apparatus.

9. The full-time dynamic power allocation method of the claim 8, further applied to a fourth electronic apparatus, the multi-port output charging apparatus further comprising a plurality of common charging ports and a priority charging port, the first electronic apparatus, the second electronic apparatus, and the third electronic apparatus being plugged into the common charging ports, the fourth electronic apparatus being plugged into the priority charging port, the full-time dynamic power allocation method further comprising:
allocating, by the charging circuit, a fourth allocated charging power value equal to a fourth charging specification power value of the fourth electronic apparatus to the fourth electronic apparatus.

10. The full-time dynamic power allocation method of the claim 9, wherein in a first power allocation of the multi-port output charging apparatus, the charging circuit allocates the fourth allocated charging power value equal to the fourth charging specification power value of the fourth electronic apparatus to the fourth electronic apparatus;
wherein in the first power allocation of the multi-port output charging apparatus, the charging circuit sets the first allocated charging power value of the first electronic apparatus, the second allocated charging power value of the second electronic apparatus, and the third allocated charging power value of the third electronic apparatus, based on a ratio among a first charging specification power value of the first electronic apparatus, the second charging specification power value of the second electronic apparatus, and the third charging specification power value of the third electronic apparatus, using a remaining power value obtained by subtracting the fourth allocated charging power value from a charging capability maximum wattage value of the charging circuit, or, the charging circuit sets the first allocated charging power value of the first electronic apparatus, the second allocated charging power value of the second electronic apparatus, and the third allocated charging power value of the third electronic apparatus, based on the charging voltage specifications, the charging current specifications, the charging power specifications, or the brands of the first electronic apparatus, the second electronic apparatus, and the third electronic apparatus, using the remaining power value obtained by subtracting the fourth allocated charging power value from the charging capability maximum wattage value of the charging circuit.
